(19) United States
(12) Patent Application Publication
(10) Pub. No.: US 2017/0111335 A1
(43) Pub. Date: Apr. 20, 2017

(54) SYSTEMS AND METHODS FOR AGENT-BASED PASSWORD UPDATES

(71) Applicant: BeyondTrust Software, Inc., Phoenix, AZ (US)

(72) Inventors: Brad Hibbert, Carp (CA); Gyle Iverson, Phoenix, AZ (US); Julie Lustig-Rusch, Phoenix, AZ (US); James Mitchell, Phoenix, AZ (US); Jeffery Nielsen, Phoenix, AZ (US)

(21) Appl. No.: 15/390,600

(22) Filed: Dec. 26, 2016

Related U.S. Application Data
(63) Continuation-in-part of application No. 14/983,418, filed on Dec. 29, 2015, now Pat. No. 9,531,726.
Application No. 14/983,418 is a continuation of application No. 14/327,087, filed on Jul. 9, 2014, now Pat. No. 9,225,723.
Application No. 14/327,087 is a continuation of application No. 12/571,231, filed on Sep. 30, 2009, now Pat. No. 8,863,253.
Application No. 12/571,231 is a continuation-in-part of application No. 12/497,429, filed on Jul. 2, 2009, now Pat. No. 9,160,545.
(60) Provisional application No. 62/274,058, filed on Dec. 31, 2015.
(60) Provisional application No. 61/219,359, filed on Jun. 22, 2009.

(51) Int. Cl. H04L 29/06

(52) U.S. Cl. CPC H04L 63/068; H04L 63/083; H04L 63/20; H04L 63/0876

(57) ABSTRACT

A method comprising: storing a plurality of device records, at least one device record including a digital device identifier that identifies at least one digital device in non-persistent communication, a current password associated with the digital device identifier, and a policy identifier that identifies at least one policy indicating when an updated password will be generated for the at least one digital device identified by the digital device identifier. The example method further comprises determining whether at least one condition identified by the at least one policy is satisfied, generating an updated password only if the at least one condition is satisfied, receiving a password update request initiated from a security agent executing on the at least one digital device, and providing the updated password to replace at least one password on the at least one digital device only if the at least one condition is satisfied.

### CROSS-REFERENCE TO RELATED APPLICATIONS

This U.S. Non-Provisional patent application claims the benefit of U.S. Provisional Patent Application No. 62/274,058, filed Dec. 31, 2015, entitled “Systems and Methods for Agent-Based Password Updates”, the contents of which are expressly incorporated herein by this reference as though set forth in their entirety. The present application is also a continuation-in-part of U.S. patent application Ser. No. 14/983,418, filed Dec. 29, 2015, entitled “Systems and Methods for Automatic Discovery of Systems and Accounts,” now U.S. Pat. No. 9,531,726, which is a continuation of U.S. patent application Ser. No. 14/327,087, filed Jul. 9, 2014, entitled “Systems and Methods for Automatic Discovery of Systems and Accounts,” now U.S. Pat. No. 9,225,723, which is a continuation of U.S. patent application Ser. No. 12/571,231, filed Sep. 30, 2009, entitled “Systems and Methods for Automatic Discovery of Systems and Accounts,” now U.S. Pat. No. 8,863,253, which is a continuation-in-part of U.S. patent application Ser. No. 12/497,429, filed Jul. 2, 2009, entitled “Systems and Methods for A2A and A2DB Security Using Program Authentication Factors,” now U.S. Pat. No. 9,160,545, which claims priority to U.S. Provisional Patent Application Ser. No. 61/219,359, filed Jun. 22, 2009, entitled “Systems and Methods for A2A and A2DB Security Using Program Authentication Factors,” which are all hereby incorporated herein this by reference as though set forth in their entirety and priority to which is claimed.

### FIELD OF USE

Various embodiments discussed herein relate generally to organized updating security measures on a user device. More particularly, various embodiments relate to systems and methods that utilize an agent executing on the user device to facilitate password updates in conjunction with a security system.

### BACKGROUND

All too often, too many users of a network are granted full, unrestricted super-user, root, or administrator privileges, regardless of whether or not access is needed. Even if unrestricted access is needed occasionally, many users maintain full, unrestricted access persistently. This “all trusting” environment is insecure to both inside and outside attacks. Further, this type of approach is frequently coupled with a lack of accountability of this access. These privileged accounts are often exploited by unethical insiders and hackers to perpetrate fraud, steal data, and/or damage systems.

A similar issue exists with non-human processes in the area of application-to-application (A2A) or application-to-database (A2DB) communication involving service accounts on various IT systems. The passwords for these accounts are often hard-coded or embedded in the calling application or script and rarely, if ever, changed. Couple this with the fact that any skilled administrator or programmer with access to the application source code or script can view those passwords, and the potential damage associated around exploitation moves to a higher dimension that may be even harder to spot and prevent.

Due to the depth of access that privileged and embedded passwords provide to highly sensitive and confidential information, and the fact that these access credentials are shared among administrators, it is only natural that security experts and compliance auditors are recommending and requiring more scrutiny and control in this area. Without a system of checks and balances and overall accountability for privileged and embedded passwords, an organization is open to exploitation and exposes mission-critical systems to intentional or accidental harm and malicious activity.

Therefore what is needed is needed is a computer-implemented method for storing a plurality of device records, at least one device record including: a digital device identifier that identifies at least one digital device in non-persistent communication, a current password associated with the digital device identifier, and a policy identifier that identifies at least one policy indicating when an updated password will be generated for the at least one digital device identified by the digital device identifier.

### SUMMARY

To minimize the limitations in the prior art, and to minimize other limitations that will become apparent upon reading and understanding the present specification, the following discloses a new and useful computer-implemented method for storing a plurality of device records, at least one device record including: a digital device identifier that identifies at least one digital device in non-persistent communication, a current password associated with the digital device identifier, and a policy identifier that identifies at least one policy indicating when an updated password will be generated for the at least one digital device identified by the digital device identifier.

An example method comprises storing, in a memory configured to cooperate with a processor, a plurality of device records, at least one device record including: a digital device identifier that identifies at least one digital device in non-persistent communication with the processor, a current password associated with the digital device identifier, and a policy identifier that identifies at least one policy indicating when an updated password will be generated by the processor for the digital device identified by the digital device identifier. The example method further comprises determining, by the processor, whether at least one condition identified by the at least one policy is satisfied, generating, by the processor, an updated password to replace the current password only if the at least one condition is satisfied, receiving, at the processor, a password update request initiated from a security agent executing on the at least one digital device, the password update request including at least a device identifier that identifies the at least one digital device, and providing, by the processor to the at least one digital device, the updated password to replace at least one password on the at least one digital device only if the at least one condition is satisfied.

The method may further comprise determining, by the processor, whether the at least one password on the at least one digital device was successfully updated based upon a message sent from the at least one digital device. The method may also comprise generating, by the processor, a second password in response to determining that the at least one password was not successfully updated, and transmitting the second password to the at least one digital device.

In some embodiments, at least one policy identified in the at least one device record indicates the at least on condition is an elapsed predetermined period of time since last update, a scheduled date, or a frequency of update of the at least one digital device. In various embodiments, the updated password is generated after the password update request is received by the processor.

The method may further comprise encrypting by the processor, the updated password based upon a predetermined encryption protocol. In some embodiments, the method may further comprise establishing an active communication connection between the processor and the at least one digital device, the active communication connection enabling the processor to receive the password update request. In various embodiments, the method may further comprise comprising storing, by the processor, the updated password and updating the at least one device record.

The method may further comprise updating an update schedule record associated with the at least one policy, the update schedule record indicating when the at least one digital device received the updated password. Determining, by the processor, whether the at least one condition identified by the at least one policy is satisfied may comprise determining, by the processor, whether the at least on condition is satisfied base, at least in part, on the update schedule record.

An example system comprises a processor and memory. The memory may comprise a security management database, a security system update module, and a security system communication module. The security management database may store a plurality of device records, at least one device record including: a digital device identifier that identifies at least one digital device in non-persistent communication with the processor, a current password associated with the digital device identifier, and a policy identifier that identifies at least one policy indicating when an updated password will be generated by the processor for the digital device identified by the digital device identifier. The security system update module may be configurable by the processor to determine whether at least one condition identified by the at least one policy is satisfied and to generate an updated password to replace the current password only if the at least one condition is satisfied. The security system communication module may be configurable by the processor to receive a password update request initiated from a security agent executing on the at least one digital device, the password update request including at least a device identifier that identifies the at least one digital device and to provide to the at least one digital device, the updated password to replace at least one password on the at least one digital device only if the at least one condition is satisfied.

An example computer readable medium may comprise executable instructions. The executable instructions may be executable by a processor to perform a method. The method may comprise storing, in a memory configured to cooperate with a processor, a plurality of device records, at least one device record including: a digital device identifier that identifies at least one digital device in non-persistent communication with the processor, a current password associated with the digital device identifier, and a policy identifier that identifies at least one policy indicating when an updated password will be generated by the processor for the digital device identified by the digital device identifier. The example method further comprises determining, by the processor, whether at least one condition identified by the at least one policy is satisfied, generating, by the processor, an updated password to replace the current password only if the at least one condition is satisfied, receiving, at the processor, a password update request initiated from a security agent executing on the at least one digital device, the password update request including at least a device identifier that identifies the at least one digital device, and providing, by the processor to the at least one digital device, the updated password to replace at least one password on the at least one digital device only if the at least one condition is satisfied.

Another example method may comprise detecting, by a security agent on a digital device that may be in non-persistent communication with the processor, access to a security system, providing, by the security agent, a password update request only when access to the security system is detected, and receiving one or more password update messages by the security agent from the security system. The method may further comprise determining by the security agent using the one or more password update messages whether to update one or more passwords associated with one or more accounts for applications or services on the digital device. The method may include retrieving one or more passwords from the one or more password update messages and updating previously existing passwords of the one or more accounts.

In some embodiments, the method may further comprise encrypting the password update request, decrypting one or more of the password update messages, decrypting one or more passwords, establishing an encrypted communication between the security agent and the security system, and/or providing a message to the security agent indicating whether one or more passwords were successfully updated.

One embodiment may be a computer-implemented method for providing agent-based password updates comprising: storing, in a memory configured to cooperate with a processor, a plurality of device records; wherein at least one device record of the plurality of device records comprises: a digital device identifier that identifies at least one digital device in non-persistent communication with the processor, a current password associated with the digital device identifier, and a policy identifier that identifies at least one policy indicating when an updated password will be generated by the processor for the at least one digital device identified by the digital device identifier; determining, by the processor, whether at least one condition identified by the at least one policy is satisfied; generating, by the processor, an updated password to replace the current password only if the at least one condition is satisfied; receiving, by the processor, a password update request initiated from a security agent executing on the at least one digital device, the password update request comprises the at least one device identifier that identifies the at least one digital device; and providing, by the processor to the at least one digital device, the updated password to replace the current password on the at least one digital device only if the at least one condition is satisfied. The method may further comprise: determining, by the processor, whether the current password on the at least one digital device was successfully updated based upon a message sent from the at least one digital device; and generating, by the processor, a second updated password in response to determining that the current password was not successfully updated, and transmitting the second updated password to the at least one digital device. The at least one policy identified in the at least one device record may indicate the at least one condition may be selected from the group of conditions consisting of: an elapsed predetermined period of time since a last update; a scheduled date; and a frequency of update of the at least one digital device. The updated password may be generated after the password update request is received by the processor. The method may further comprise the steps: encrypting, by the processor, the updated password based upon a predetermined encryption protocol; establishing an active communication connection between the processor and the at least one digital device, the active communication connection may allow the processor to receive the password update request; storing, by the processor, the updated password; updating the at least one device record; and updating an update schedule record associated with the at least one policy, the update schedule record indicating when the at least one digital device received the updated password. Preferably the step of determining, by the processor, whether the at least one condition identified by the at least one policy is satisfied may comprise: determining, by the processor, whether the at least one condition is satisfied based, at least in part, on the update schedule record.

Another embodiment may be a system comprising: a processor; and memory, the memory preferably comprising: a security management database storing a plurality of device records, at least one device record of the plurality of device records comprising: a digital device identifier that identifies at least one digital device in non-persistent communication with the processor, a current password associated with the digital device identifier, and a policy identifier that identifies at least one policy indicating when an updated password will be generated by the processor for the at least one digital device identified by the digital device identifier; a security system update module configurable by the processor to determine whether at least one condition identified by the at least one policy is satisfied and to generate an updated password to replace the current password only if the at least one condition is satisfied; and a security system communication module configurable by the processor to: receive a password update request initiated from a security agent executing on the at least one digital device, the password update request comprising the at least one device identifier that identifies the at least one digital device, and provide the updated password to the at least one digital device to replace the current password on the at least one digital device only if the at least one condition is satisfied. The system may further comprise: a security system authentication module configurable by the processor to determine whether the at least one password on the at least one digital device was successfully updated based upon a message sent from the at least one digital device. The security system update module may be further configurable by the processor to generate a second updated password in response to determining that the current password was not successfully updated, and the security system communication module may be further configurable by the processor to transmit the second updated password to the at least one digital device. The at least one policy identified in the at least one device record indicates the at least one condition is selected from the group of conditions consisting of: an elapsed predetermined period of time since a last update; a scheduled date; and a frequency of update of the at least one digital device. The updated password may be generated after the password update request is received by the processor. The memory may further comprise: a security system encrypt/decrypt module configured to encrypt the updated password based upon a predetermined encryption protocol. The security system communication module may be further configurable by the processor to establish an active communication connection between the processor and the at least one digital device, the active communication connection allows the processor to receive the password update request. The security system update module may be further configurable by the processor to store the updated password and update the at least one device record. The memory may further comprise: a security system schedule queue configured to update an update schedule record associated with the at least one policy, the update schedule record may indicate when the at least one digital device received the updated password; wherein the security system update module may be configurable by the processor to determine whether the at least one condition identified by the at least one policy is satisfied may comprise: determining whether the at least one condition is satisfied based, at least in part, on the update schedule record.

Another embodiment may be a non-transitory computer readable medium comprising executable instructions, the executable instructions being executable by a processor to perform a method, the method comprising the steps: storing, in a memory configured to cooperate with the processor, a plurality of device records, at least one device record of the plurality of device records comprising: a digital device identifier that identifies at least one digital device in non-persistent communication with the processor, a current password associated with the digital device identifier, and a policy identifier that identifies at least one policy indicating when an updated password will be generated by the processor for the at least one digital device identified by the digital device identifier; determining, by the processor, whether at least one condition identified by the at least one policy is satisfied; generating, by the processor, an updated password to replace the current password only if the at least one condition is satisfied; receiving, by the processor, a password update request initiated from a security agent executing on the at least one digital device, the password update request comprising the at least one device identifier that identifies the at least one digital device; and providing, by the processor to the at least one digital device, the updated password to replace the current password on the at least one digital device only if the at least one condition is satisfied.

It is an object of the new method to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a system and environment for updating passwords on a client device over a computer network having non-persistent communication connections according to some embodiments.

FIG. 2 is a block diagram of one embodiment of a client device including a security agent according to some embodiments.

FIG. 3 is a block diagram of one embodiment of a security agent of a client device according to some embodiments.

FIG. 4 is a block diagram of one embodiment of a security system according to some embodiments.

FIG. 5 is a flow diagram of one embodiment of a method of operation for a security agent according to some embodiments.

FIG. 6 is a flow diagram of one embodiment of a method of operation for a security system according to some embodiments.

FIG. 7 is a block diagram of one embodiment of a digital device according to some embodiments.

### DETAILED DESCRIPTION OF THE ILLUSTRATIVE EMBODIMENTS

In the following detailed description of various embodiments, numerous specific details are set forth in order to provide a thorough understanding of various aspects of one or more embodiments. However, these embodiments may be practiced without some or all of these specific details. In other instances, well-known methods, procedures, and/or components have not been described in detail so as not to unnecessarily obscure aspects of embodiments of the invention.

While multiple embodiments are disclosed, other embodiments will become apparent to those skilled in the art from the following detailed description, which shows and describes illustrative embodiments. As will be realized, the invention is capable of modifications in various obvious aspects, all without departing from the spirit and scope of protection. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of the following embodiments. For example, as used herein, the terms “computer” and “computer system” generally refer to any device that processes information with an integrated circuit chip.

As used herein, the terms “software” and “application” refer to any set of machine-readable instructions on a machine, web interface, and/or computer system” that directs a computer's processor to perform specific steps, processes, or operations disclosed herein. The application or software may comprise one or more modules that direct the operation of the computer system on how to perform the disclosed method.

As used herein, the term “computer-readable” medium may refer to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

Certain functions of various operating systems (e.g., OS X® operation system) and applications (e.g., OS X® applications) generally require privileged operations. In order for a computer system to perform these privileged operations, a user generally must be a member of an administrator group or domain, as a member of these groups generally can perform any privileged operation without a restriction.

In various embodiments, local accounts (e.g., user accounts, service accounts, and the like) installed on a computer may be periodically updated. For example, credentials (e.g., username and/or password) associated with the accounts may be updated by a remote security system via a network. Unfortunately, it may be difficult to change credentials of computers with periodic network accessibility or unreliable network connections. Examples of computers with periodic network accessibility include mobile devices (e.g., smartphones, laptops, netbooks, tablets, wearable devices and the like) that may only periodically have network access depending on the user and location when the mobile device(s) are active. Examples of computers with unreliable network connections include any computer that is periodically disconnected from a network, periodically powered off, or periodically suffers from bad network connectivity due to a bad network card or poor network support (e.g., a bad router or poor physical connection).

In some embodiments, a security agent executing on a computer with periodic or unreliable network connectivity is configured to facilitate updating account credentials. When a security system and/or security software is accessible over a network, the security agent may detect that the security system and/or software is accessible. Subsequently, the security agent may provide a message to the security system and/or software. The message may indicate that the computer is available for software updates. The security agent may receive updated passwords from the security system and/or software for any number of accounts on the computer. The security agent may, in some embodiments, assist with changing passwords on the computer. In one example, the security agent may change internal passwords of the computer. Passwords that the security agent may change may include passwords to the hardware of the computer, operating system passwords, passwords to various programs and/or applications on the computer, or the like.

This approach may be helpful in environments with unreliable network connections, or environments in which a computer is unable to consistently receive in-bound connections from the security system. For example, instead of the security system repeatedly initiating a password update to an offline or otherwise unavailable computer, the security agent may initiate the request for an updated password when the offline computer becomes available (e.g., comes back online, is hard-connected to a network, or has a network connection with a sufficient quality of service). It will be appreciated that a password agent may be used on conjunction with any digital device described herein that has unreliable and/or unscheduled connectivity.

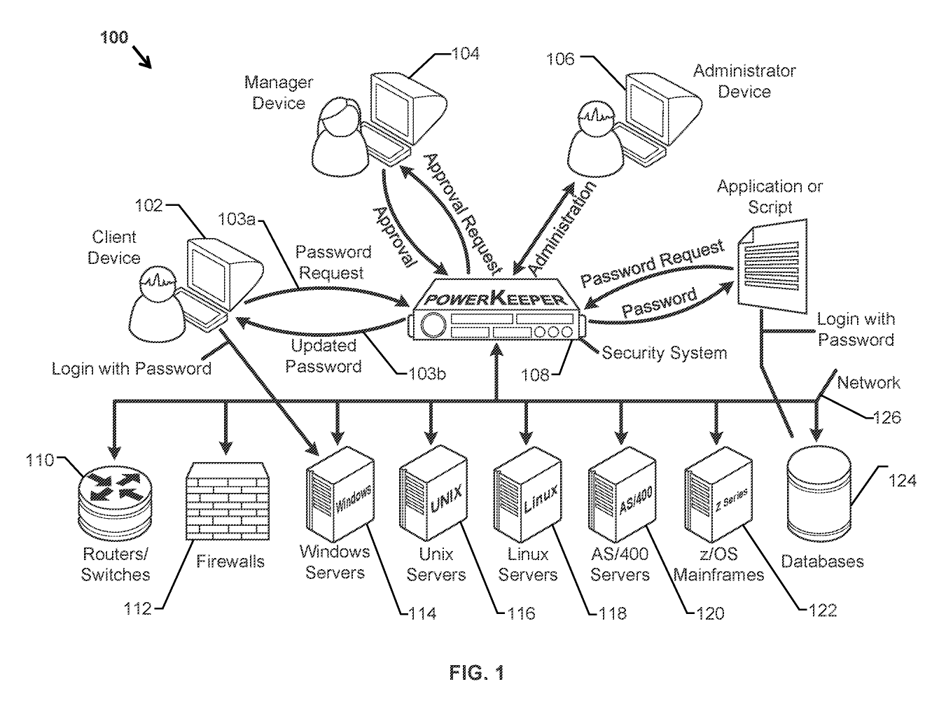

FIG. 1 is an illustration of one embodiment of a system and environment for updating passwords on a client device over a computer network having non-persistent communication connections according to some embodiments. FIG. 1 illustrates a system and environment 100 for updating passwords on a client device 102 over a computer network 126 having non-persistent communication connections according to some embodiments. The system and environment 100 includes a client device 102 (or “user device”), a manager device 104, and an administrator device 106, each of which may each communicate with a security system 108. Routers/switches 110, firewalls 112, windows servers 114, Unix® servers 116, Linux servers 118, AS/400 servers 120, z/OS mainframes 122, and databases 124 may each be operatively coupled to a network 126 which may be operatively coupled to the security system 108.

In various embodiments, a digital device may comprise the client device 102, the manager device 104, the administrator device 106, the security system 108, routers/switches 110, firewalls 112, the Windows® servers 114, the Unix® servers 116, the Linux® servers 118, the AS/400 servers 120, the z/OS mainframes 122, and/or the databases 124. It will be appreciated that a digital device is any device with a processor and memory, such as a computer. Digital devices are further described herein.

The client device 102 is any digital device with one or more accounts (e.g., user accounts, service accounts, and the like) and a security agent to facilitate updating account credentials (e.g., encrypted or unencrypted passwords). For example, the client device 102 may be a mobile device, laptop, smartphone, desktop, hardened device, server, and/or so forth.

In some embodiments, the client device 102 is a digital device with periodic or unreliable connectivity to a network (e.g., a network accessible to the security system 108 security system 108). As discussed herein, the client device 102 may be any mobile device such as a laptop that is only periodically connected to a network that is accessible to the security system 108 (e.g., a network that has access to the network 126). In another example, the client device 102 may be any digital device with at least occasional wired or occasional unwired connectivity to a network that is accessible by the security system 108.

In some embodiments, the client device 102 is any digital device with an application that may seek access to a secured application and/or secured database. In one example, the user of the client device 102 may be an accountant and the seeking application may be Microsoft Access. The accountant may wish to access a secured accounting database on a network (e.g., stored within the databases 124). Before the seeking application gains access to the secured accounting database, a request to access the database (e.g., a registration request) may be approved. Once approved, the client device 102 may receive a password to be stored within the client device 102. Alternately, the password is not stored within the client device 102 but rather the client device 102 may receive the password when the seeking application requests access to the secured application. In some embodiments, the password may be associated with an expiration event after which the password is expired and the client device 102 must then request another password. The process of registering and seeking passwords is further described herein.

It will be appreciated that, in some embodiments, the secured database may be on the client device 102 and the seeking application on another device that is on the network 126. Similar to the example above, before the seeking application gains access to the secured database on the client device 102, the client device 102 may be accessible over the network 126 and a request to access the database (e.g., a registration request) may be approved by the security system 108. Once approved by the security system 108, assuming the client device 102 is accessible, the seeking application (or the digital device of the seeking application) may receive a password to access the secured database.

A seeking application is any application that requires a password or other authentication information before accessing a secure application and/or secured database. A secured application is any application that requires a password or other authentication information before being able to access the secured application. Similarly, a secured database is any database that requires a password or other authentication information before access is granted. It will be appreciated that a secured database may refer to any secured data structure and is not limited only to databases (e.g., a secured table).

The client device 102 may further include a security agent. The client device 102 is further discussed herein.

The manager device 104 is any digital device that may approve a registration request. In some embodiments, the client device 102 may provide a registration request. The registration request may include information about the user of the client device 102 (e.g., login information), the client device 102, itself, and/or a seeking application. The manager and/or an application on the manager device 104 may review the registration request and approve or deny the request. In one example, the manager device 104 is operated by a manager that may approve a registration request from the client device 102. In another example, the manager device 104 may be configured to automatically approve one or more registration requests. In some embodiments, the manager of the manager device 104 may approve one or more components of the registration request (e.g., program factors discussed herein) and the manager device 104 is configured to approve the same or different components of the registration request.

In another example, the manager may receive the registration request that indicates the user and the seeking application. If the user is authorized for access (e.g., the user is an accountant seeking access for financial information) and the seeking program is confirmed based on program factors, the manager may approve the registration request, thereby allowing the seeking application access. It will be appreciated that there may be any number of ways a manager and a managing device 104 may, either in combination or separately, review and examine registration requests for approval or denial. Further, it will be appreciated that the manager device 104 may be optional and the approval process may take place within the security system 108 (further described herein) and/or the administrator device 106.

The administrator device 106 is any digital device that configures the security system 108. In various embodiments, the administrator device 106 is operated by an administrator (e.g., a network administrator, security officer, or IT professional) who can configure the security system 108. In one example, the administrator device 106 may display a configuration interface (e.g., a web page from the security system 108) that allows configuration. The administrator device 106 may configure the security system 108 to perform different tasks depending upon the seeking application, the user of the client device 102, and/or the client device 102. In one example, the administrator device 106 may specify specific manager devices 104 which must approve a registration request from a specific user name before the registration request may be approved and access to a secured application provided (e.g., via a password). The administrator device 106 may also specify program factors that must be confirmed as well as what the values of the program factors are expected to be. It will be appreciated that the security system 108 may be configured in any number of ways.

The security system 108 may comprise hardware, software, or a combination of both. In various embodiments, a digital device includes the security system 108. The digital device may be cabled to (or otherwise in communication with) the network 126. In some embodiments, the security system 108 may comprise software configured to be run (i.e., executed) by a server, router, or other device. The security system 108 may also comprise hardware. For example, the security system 108 may comprise a Windows® 2003 server (such as a hardened Windows® 2003 server), with quad-core CPUs, hot swap mirrored drives, redundant power supplies, and redundant fans. The security system 108 may also comprise redundant CPUs and hot-bank memory.

In various embodiments, the security system 108 is configured (e.g., by an administrator and/or the administrator device 106) to provide security for accounts, applications and databases. In some examples, the security system 108 may be configured to generate and update account passwords, process registration requests, and log relevant information. In some embodiments, the security system 108 is configured to generate updated passwords, and, in response to receiving an update request 103a, transmit them via message 103b to the client device 102.

In various embodiments the security system 108 is configured to generate an updated password for a secure application and/or secured application. In one example, software to create a password for a specific secured database (e.g., a secured SQL database) may be stored within or by the security system 108. The security system 108 may then execute the software. The software may comprise executable instructions which are executable by a processor to perform a method for creating or changing a password for one or more secured applications and/or secured databases. The security system 108 may interact directly (or indirectly) with one or more digital devices, secured applications, and/or secured databases to create or change the password. Once the password is generated, the security system 108 may store the password.

The security system 108 may also update the password to the secured application and/or the secured database. In various embodiments, the security system 108 determines an expiration event after which a password is expired (e.g., after a predetermined time or date). At that time, the security system 108 may change the password to the secured application and/or the secured database. In one example, the security system 108 interacts with the secured application and/or the secured database to change the password and then the security system 108 may store the password. The predetermined time or date may be any time or date. For example, the security system 108 may change a password of a secured application or database after a period of time (e.g., every day, hour, minute, or the like). The security system 108, for example, may change any number of passwords every thirty seconds while changing other passwords every week. It will be appreciated that any period of time may be used. Similarly, the security system 108 may change any number of passwords at a scheduled time and/or day.

It will be appreciated that the security system 108 may encrypt generated password(s) and/or encrypt storage where the password(s) is stored. The security system 108 may encrypt communications between the security system 108 and any other digital device (e.g., all communication between the client device 102 and the security system 108 may be encrypted). For example, the security system 108 may perform FIPS-140 validated encryption of data and communications, access control mechanisms, secure storage of credentials, and/or secure audit trails. The security system 108 may also comprise a sealed operating system.

The security system 108 may process registration requests. In one example, prior to a seeking application on a client device 102 being allowed to access a secured application or secure database, the security system 108 may require registration. The client device 102 may then provide a registration request to the security system 108. The registration request may include information regarding the user, the client device 102, and/or the seeking application. Based on a prior configuration, the security system 108 may, based on the user, the client device 102, and/or the seeking application, review the registration request and/or route the registration request to one or more manager devices 104 for approval. In one example, the security system 108 may be configured to determine if the client device 102 and/or the user logged into the client device 102 have rights to the secured application and/or secured database. If the client device 102 and/or the user do not have rights, the security system 108 may be configured to deny the registration request. The security system 108 may also be configured to email or otherwise contact one or more manager devices 104 to receive approval for the registration request. For example, the administrator may configure the security system 108 to email all registration requests associated with a particular seeking application to a predetermined number of managers and/or manager devices 104. In some embodiments, the security system 108 may not approve the registration request until all managers and/or manager devices approve the registration.

The security system 108 may be configured to log all registration requests, passwords, password changes, and/or password requests thereby creating a record of the activities of each user, client device 102, and/or seeking application. In some embodiments, the logs of the security system 108 may be used to confirm that the secured application and/or the secured database are being used as approved. The logs may also be encrypted. In various embodiments, the logs may be audited (e.g., by the administrator and/or the administrator device 106). The security system 108 may also be configured to provide reports regarding user/approver, requester activities, password maintenance, user and file entitlement (rights) and/or internal diagnostics. In a few examples, the reports may be exportable in CSV and HTML formats.

Although FIG. 1 shows curved lines between the client device 102 and the security system 108, the manager device 104 and the security system 108, as well as the administrator device 106 and the security system 108, it will be appreciated that the client device 102, manager device 104, and administrator device 106 may not be each directly connected to the security system 108. In one example, the client device 102, manager device 104, and administrator device 106 may be in communication with the security system 108 over one or more networks. The curved lines in FIG. 1 may depict the nature of the communication between a digital device and the security system 108. In one example, in order to receive a password to log into the windows servers 114, the client device 102 may send a password request to the security system 108. The security system 108 may be configured by the administrator device 106 (e.g., as depicted in FIG. 1 as “administration”) to send the password request to the manager device 104 for approval. The manager device 104 may send the approval to the security system 108 which may then provide the password to the client device 102. The password may then be provided to the Windows servers 114. In some embodiments, the password is not visible or displayed to the user of the client device 102.

In another example, the client device 102 may comprise a seeking application or script that seeks access to a secured database. Prior to access, the client device 102 (e.g., via the seeking application or script) may provide the password request to the security system 108 which may either provide the password or provide the password after the proper approvals have been obtained. The password may then be sent to the client device 102 which may log into the secured database to obtain access with the password.

It will be appreciated that the security system may not be limited to password management. Although various embodiments described herein refer to generating, changing, and providing passwords to access the secured application and/or the secured database, similar systems and methods may be used with any form of security, including the issuance of encryption keys (e.g., private or public keys), certificates, digital signatures, decryption keys, credentials as well as rights management to files, volumes, and/or devices. Instead of a password being provided to the client device 102, the security system 108 may alter user rights such that the user may view, access, make changes to, and/or share the secured application and or secured database. In some embodiments, the security system 108 may provide a password to the client device 102 as well as make changes to file rights. The security system 108 may provide access in any number of ways.

In some embodiments, the client device 102 may be required to provide a registration request for rights to a program or database on another digital device. The rights may include, but are not limited to, rights to view, access, make changes, and share with other users. The security system 108 may perform similar tasks as when a password is requested. In one example, the security system 108 may examine the registration request and analyze program factors to ensure that the seeking application, user, or client device 102 is authorized and/or authenticated. One or more manager devices 104 may also approve the registration request. Upon approval, the security system 108 may grant any number of rights to access the application or database. Further, the security system 108 may generate a new password for the sought application or database and/or provide the password to the client device 102.

Although the security system 108 is depicted as communicating directly over the network 126, the security system 108 may also communicate indirectly over the network 126. In one example, the security system 108 may be a part of or otherwise coupled to the client device 102, the manager device 104, the administrator device 106, the security system 108, the routers/switches 110, the firewalls 112, the windows servers 114, the Unix® servers 116, the Linux® servers 118, the AS/400 servers 120, the z/OS mainframes 122, and the databases 124. Alternately, it will be appreciated that there may be multiple networks and the security system 108 may communicate over all, some, or one of the multiple networks.

The security system 108 may comprise a software library that provides a programmatic interface to the security system 108. In one example, an API library resident on the security system 108 may have a small set of functions that are rapidly mastered and readily deployed in new or existing applications. There may be several API libraries, for example one library for each computer language or technology, such as, Java, .NET or C/C++ languages. Each specific instance, the API library may provide the same set of functions.

The routers/switches may comprise any number of routers and/or switches. In some embodiments, the security system 108 may manage rights or access to one or more routers or switches. The client device 102 may be required to provide a registration request and receive approval before rights to access the routers or switches are approved. The routers/switches 110 may comprise Cisco routers and switches for example. In another example, the routers/switches 110 may comprise a Terminal Access Controller Access-Control System (TACACS). The routers/switches 110 may also comprise web proxies or caches including, but not limited to, BlueCoat Security Gateway devices.

The firewalls 112 may comprise hardware, software, or a combination of both hardware and software. Control to access and manage the firewalls 112 may be controlled by the security system in a method similar to that described herein. In one example, before the user of the client device 102 is permitted to access and/or configure the firewall 112, the client device 102 may be required to provide a registration request that must be approved. In a few examples, the firewalls 112 may comprise Cisco® PIX, Netscreen, Nokia® IPSO, Check Point®, or Cyberguard®.

The windows servers 114 may include any server configured with a Microsoft® Windows® operating system. In a few examples, the Microsoft operating system may be Windows® 2000, 2003, XP, Media Center, Active Directory, NT 4.0, NT Domains, Vista®, and Windows 7.

The Unix® servers 116 may include any server configured with a Unix operating system. In a few examples, the Unix operating system may be Solaris, AIX, HP-UX, Tru64, or UnixWare®. Similarly, the Linux server 118 may be any server configured with the Linux operating system. In a few examples, the Linux operating system may be Red Hat or Suse.

The AS/400 servers 120 and the z/OS servers 122 may include any server(s) with the associated operating system. Further a server may be configured with RACF, HP iLo, VMware®, BoKS, Fujitus RSB, and Radius.

The databases 124 may comprise hardware, software, or a combination of hardware and software. In one example, the databases 124 are on a file server. The databases may include Oracle® databases, Microsoft® SQL, Sybase, MySQL, DB2 or any other database for example.

It will be appreciated that many operating systems, databases, and applications may be in communication with or otherwise coupled to the network 126. The examples listed herein are not intended to be limiting and other operating systems, databases, and applications may be used in conjunction with various embodiments described herein.

The computer network 126 may provide communication between the client device 102, the manager device 104, the administrator device 106, the security system 108, routers/switches 110, firewalls 112, the windows servers 114, the Unix® servers 116, the Linux® servers 118, the AS/400 servers 120, the z/OS mainframes 122, and/or databases 124. In some embodiments the network 126 represents one or more network(s) that one or more digital devices may use to communicate. In some examples, the network 126 comprises Ethernet cables, fiber optic, or other wired network topology. In other examples, the network 126 may be wireless and support wireless communication between two or more wireless devices. It will be appreciated that the network 126 may comprise two or more networks, including wired and wireless networks.

In some embodiments, the network 126 comprises an Enterprise LAN/WAN having non-persistent network connections between the security system 108 and the client device 102. A non-persistent network connection may be any connection in which the client device 102 cannot consistently or reliably receive in-bound communication from the security system 108. For example, the network 126 may be a Wi-Fi network, and the client device 102 may be remote and/or not consistently in range of the network 126. By way of the further example, a non-persistent connection may be a poor-quality communication connection, or any other connection in which the security system 108 cannot find the client device 102 (e.g., because of DNS problems), a defective network port or card, and so forth. In some embodiments, the network connections comprise hardened connections.

Although the routers/switches 110, the firewalls 112, the windows servers 114, the Unix® servers 116, the Linux® servers 118, the AS/400 servers 120, the z/OS mainframes 122, and the databases 124 are discussed as plural, it will be appreciated that there may be any number of (including one or zero) routers/switches 110, the firewalls 112, the windows servers 114, the Unix® servers 116, the Linux® servers 118, the AS/400 servers 120, the z/OS mainframes 122, and the databases 124 and be within embodiments described herein.

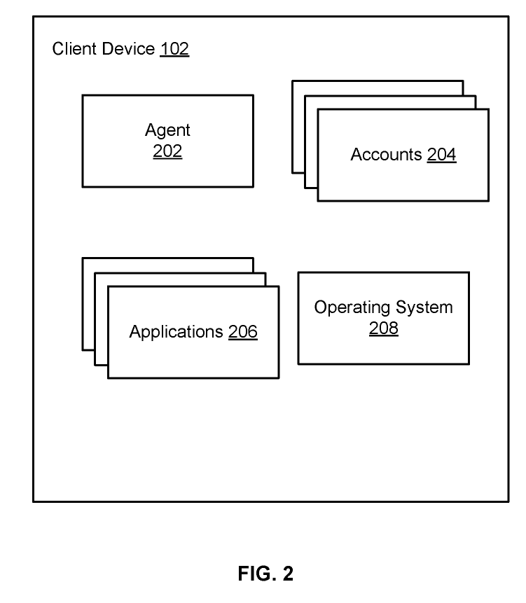

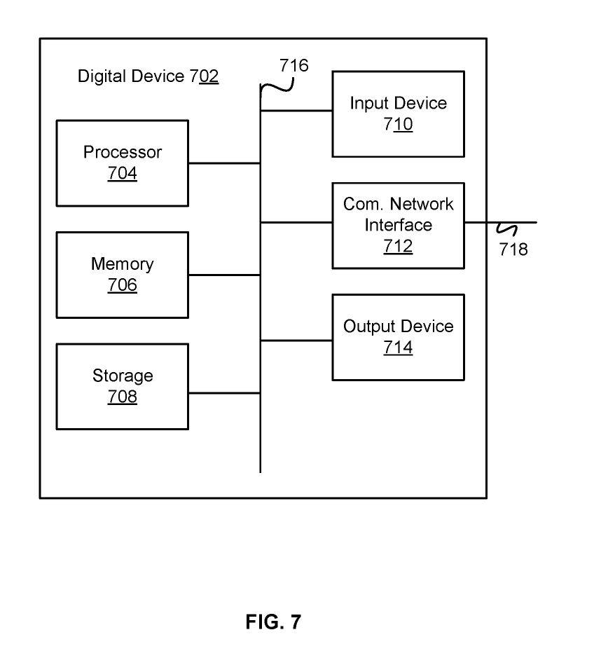

FIG. 2 is a block diagram of one embodiment of a client device including a security agent according to some embodiments. FIG. 2 is a block diagram of a client device 102 according to some embodiments. The client device 102 may be any digital device. Some examples of the client device 102 may include, for example, a mobile device, smartphone, tablet device, laptop, desktop, or hardened device. In some embodiments, the client device 102 includes a security agent 202, one or more accounts 204, applications 206, and an operating system 208, although in the other embodiments, the client device 102 may be configured otherwise. The security agent 202, accounts 204, applications 206 and/or operating system may be controlled by a processor such as the processor 704 described in relation to FIG. 7 herein.

In various embodiments, the client device 102 may have a non-persistent connection with one or more other digital devices. For example, the client device 102 may have a poor network connection with the security system 108 or is occasionally turned off. In another example, the client device 102 may be a mobile device such as a laptop or smartphone where the client device 102 is often put into a sleep mode, powered down, and/or moved to different locations that cannot communicate with the security system 108. Such a device may have intermittent network access and it may not be predictable when the device will be connected to a network. Further, while the client device 102 may occasionally obtain network access (e.g., at a coffee shop), many networks may not communicate with the security system 108. As a result, even if the client device 102 has network access, the client device 102 may not be accessible by or with the security system 108. Even if the network can communicate with the security system 108, the network may not be sufficiently secure to perform credential updates. As a result, the security agent 202 may not detect the security system 108 or may determine not to communicate with the security system 108.

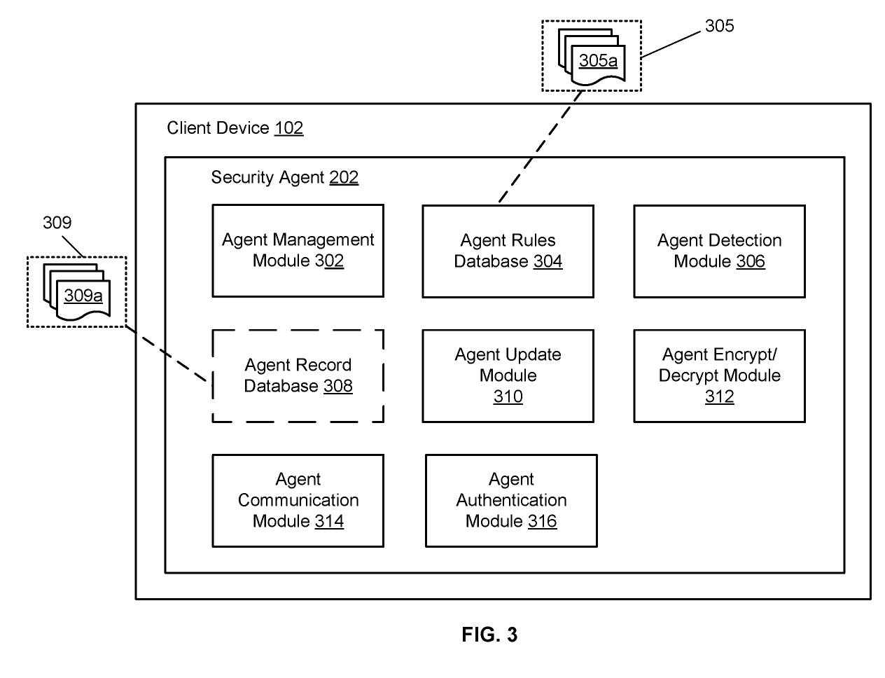

In some embodiments, in order to correct one or more of the concerns described herein, the security agent 202 resides and executes on the client device 102 and may be configured to update and/or assist in updating passwords stored on the client device 102. In various embodiments, the security agent 202 may detect when the security system 108 is or may be accessible. The security agent 202 may provide a message to the security system 108 upon satisfaction of one or more trigger conditions to notify the security system 108 that the client device 102 is accessible and may be ready to receive or trigger credential updates. In some embodiments, the security agent 202 may control execution of one or more applications 206 based on rules. The security agent 202 is further described with regard to FIG. 3.

Accounts 204 may include or be linked to any number of accounts. In one example, an account is or is linked to at least one record that enables authentication of credentials (e.g., passwords) to further enable access or other rights to information (e.g., applications, data, records, and/or other accounts).

Accounts 204, for example, may include user accounts, service accounts (e.g., accounts used to launch applications 206), or any other account that may have an associated password stored locally on the client device 102. In some embodiments, one or more accounts 204 are local to the client device 102 (e.g., not domain-based), although in other embodiments it may be otherwise. In various embodiments, each account 204 may be associated with an account identifier and a password. The password may be encrypted and/or stored on the client device 102. In various embodiments, accounts may be associated with hardware of the client device 102 (e.g., credentials necessary to access hardware services or unlock the device). The accounts may be associated with an operating system 208 (e.g., credentials associated with accessing a user profile or device access). There may be any number accounts associated with hardware or services of the client device 102.

In another example, one or more accounts 204 may be associated with information technology (IT) professionals and may be used to enable IT professionals to access an application (e.g., of applications 206), operating system 208, firmware, hardware, and/or any other aspect of the client device 102. In some embodiments, IT professionals may utilize the one or more accounts 204 to maintain the client device 102, perform updates, perform upgrades, troubleshoot, and/or otherwise provide service.

Applications 206 may include any application. An application is any program designed to enable end users to perform specific tasks, such as, but not limited to, word processing, database management, accounting, finance, spreadsheets, or communication. Applications may include, for example, word processing programs, operating systems, browsers, spreadsheets, readers, players, database applications, email applications, design applications, or the like. It will be appreciated that there may be any number of applications 206. In various embodiments, applications 206 comprise applications that have been installed and/or configured by the user of the client device 102, administrator, and/or other trusted individual.

A rule of the client device 102 may apply to all applications or a subset of applications of the applications 260. In one example, a rule may instruct the client device 102 to allow or deny launch of any application. The rule may instruct the client device 102 to allow or deny launch of any application based on one or more credentials (e.g., password) of the account associated with the application. For example, a rule may instruct the client device 102 to deny application launch if a password associated with the account used to launch the application has not been updated for a predetermined amount of time.

Operating system 208 may be any operating system. For example, the operating system 208 may be Microsoft® Windows®, OSX, Unix®, BSD, or any other operating system. In some embodiments, the security agent 202 may include an API and/or a module in communication with the operating system 208 to detect when an application is to be launched or when an active communication connection is available between the client device 102 and the security system 108.

In some embodiments, the client device 102 includes a credential storage that may store passwords and/or other credentials. The credential storage may be on any computer readable media including, for example, storage 708 in FIG. 7 discussed further with regard to FIG. 7. The credential storage may, in some embodiments, be encrypted. The credential storage may, in some embodiments, store passwords received by from the security system 108 and/or generated by the security agent 202.

FIG. 3 is a block diagram of one embodiment of a security agent of a client device according to some embodiments. FIG. 3 is a block diagram of a client device 102 including a security agent 202 according to some embodiments. The security agent 202 may be software, hardware, firmware, or a combination thereof. In one example, the security agent 202 is a client (e.g., an application) on the client device 102 configured to initiate a password update request 103a to the security system 108, receive updated passwords contained within a password update message 103b, update old passwords on the client device 102 with the updated passwords, and/or provide passwords for or to seeking applications to access a secured application and/or secured database on the client device 102.

In some embodiments, the security agent 202 executes on the client device 102 and includes an agent management module 302, an agent rules database 304, an agent detection module 306, an agent record database 308, an update module 310, an agent encrypt/decrypt module 312, an agent communication module 314, and an agent authentication module 316. In various embodiments, the agent management module 302 is configured to control the security agent 202. The agent management module 302 may be configured to update passwords to or associated with one or more account(s) 206 on the client device 102.

The agent management module 302 may be configured to create, read, update, delete, and/or otherwise access agent rules 305 stored in the agent rules database 304. Such operations may be performed manually (e.g., by an administrator interacting with a GUI) or automatically (e.g., the security agent 202 retrieving rules from the security system 108). Generally, the rules 305 include instructions to be executed by the security agent 202. In on example, rules 305 may indicate when the security agent 202 is to provide an update request (e.g., password update request, rule update request). The rules 305 may include or specify other information as well, such as encryption and decryption protocols used by the agent encrypt/decrypt module 312, discussed below. It will be appreciated that the agent rules database 304 may be any structure (e.g., active database, relational database, table, and the like) suitable for storing and managing the aforementioned rules 305.

In some embodiments, the rules 305 may be applicable to any number of the accounts 204. For example, each rule may include account identifiers for the accounts associated with that rule. The rules 305 may also contain one or more trigger conditions or trigger events that, when satisfied, trigger the security agent 202 to initiate an update request. For example, the trigger conditions or trigger events may trigger the security agent 202 to initiate the password update request 103a for the client device 102, or more specifically, for the account(s) associated with that rule. Alternatively, the trigger conditions or trigger events may trigger update requests for other data stored on the client device 102 (e.g., rules 305).

Example trigger conditions may include a date, time, time interval (e.g., every 2 hours, once a week, once a month, and so forth), and/or an event. An event, for example, may be an active connection to the security system 108 becoming available (e.g., via a network), or otherwise being established, between the client device 102 and the security system 108 after a predetermined amount of time (e.g., 24 hours) without an active connection.

For example, a rule 305a (e.g., created by a user or created by the security agent 202) may specify that the client device 102 should initiate the password update request 103a when the device 102 comes back “online” (i.e., an active connection with the security system 108 is available) after being “offline” (i.e., no active connection available with the security system 108) for a predetermined period of time (e.g., more than 24 hours) after last communicating with the security system 108.

In some embodiments, the agent management module 302 is configured to create, read, update, delete, and/or otherwise access, agent records 309 stored in the agent records database 308, and related data (e.g., account passwords) stored on the client device 102. The agent records 309 may maintain account information (e.g., account identifiers, account names, and the like) and account credentials (e.g., passwords) for the accounts 204 installed on the client device 102.

For example, the agent record database 308 may include an account and/or an account identifier that identifies one of the accounts 204 installed on the client device 102. The account identifier may be a number, character, string, or otherwise. In some embodiments, the records 309 may also include an encrypted password associated with the identified account, although in other embodiments the encrypted password may be stored or managed elsewhere on the client device 102. In some embodiments, the agent records 309 may include one or more rule or policy identifiers that identify corresponding rule(s) 305 stored in the rules database 305. It will be appreciated that the agent record database 308 may be any structure (e.g., active database, relational database, table, and the like) suitable for managing and/or storing the aforementioned records 309.

It will be appreciated that the agent records database 308 and records 309 are optional, and that such functionality (e.g., maintain account information, passwords, and the like) may be included in other features of the security agent 202 or client device 102 (e.g., operating system 208).

The agent detection module 306 may be configured to determine whether any of the accounts 204 on the client device 102 require updating based on the rules 305. For example, the accounts 204 may be associated with a password (encrypted or otherwise) and one or more rules 305 stored in the rules database 304, as discussed above, and when the rule conditions and/or events are satisfied, the agent detection module 306 may trigger the agent update module 310 to request an update.

The agent detection module 306 may be further configured to determine whether an active communication connection is available between the client device 102 and the security system 108. For example, an active communication connection may be unavailable to the client device 102 when it is out of range of the network 126, or is otherwise unable to receive an in-bound communication from the security system 108. Similarly, an active connection may be available to the client device 102 when it returns within range of the network 126, or otherwise able to receive an in-bound connection from the security system 108. For example, the agent detection module 306 may periodically attempt (or assist in attempting) to connect or otherwise communicate with the security system 108 to test for an active communication connection, or monitor a portion of the operating system 208 that detects available network signals.

In some embodiments, the agent detection module 306 may be configured to store a list or other data structure identifying networks that may access (or a have permission to access) the security system 108. For example, the agent detector module 306 may compare an SSID of one or more available networks to a list of network identifiers that have access to the security system 108. If the client device 102 accesses a network that is identified by one of the stored network identifiers, the agent detection module 306 may trigger sending a request from the security agent 202 to the security system 108. The request may be a request to update passwords (or request another module to perform an update request) or may trigger a review of rules 305 to determine if the security agent 108 should be sent a message (e.g., if a predetermined period of time since last connection with the security agent 108 has not elapsed based on a rule 305).

Generally, the agent update module 310 may be configured to update information stored on the client device 102. For example, the agent update module 310 may be able to update account information (e.g., identifiers, names), account credentials (e.g., passwords), and rules (e.g., identifiers, trigger conditions and events, and so forth). In some embodiments, the agent update module 310 (e.g., upon satisfaction of one or more rules 305) may or generate a password update request message 103a. The password update request message 103a may, for example, be generated in response to the agent detection module 306 triggering an update request based on one of the rules 305 stored in the rules database 304.

The update request message 103a may include, among other things, characteristics and/or attributes of the client device 102 and/or accounts 204 installed thereon. The characteristics and/or attributes may include for example, a device identifier, a device name, a fully qualified domain name (FQDN), a domain name, an IP address, a MAC address, an account name, an account identifier, a user name, a user ID, a CPU ID, a CPU serial number, a root disk volume, an OS version, an OS type, and so forth. It will be appreciated that the device identifier and the account identifier may be a number, character, string, or other identifier that may each identify, at least with respect to the client device 102 and the security system 108, the device and account associated with those identifiers.

In some embodiments, the agent update module 310 may update passwords stored on the client device 102 based upon password update messages 103b received from the security system 108. For example, the update module 310 may look up an account identified in the received password update message 103b, and replace the existing “old” password with the “new” password contained in the received message 103b. More specifically, the update module 310 may use an account identifier specified in the password update message 103b to search the accounts 204 or agent record database 308 for an account with a corresponding identifier, and update the associated password.

In some embodiments, the agent update module 310 may generate new passwords without receiving new passwords from the security system 108. For example, the security system 108 may provide a message to update passwords to the agent update module 310. The agent update module 310 may generate any number of passwords on the client device 102. The agent update module 310 may provide any number of the passwords to the security system 108 or, alternatively, may not provide any newly generated passwords to the security appliance. In some embodiments, the agent update module 310 may receive one or more passwords to use as new passwords on the client device 102 from the security system 108 and, in addition, the agent update module 310 may generate one or more passwords for the client device 102.

In some embodiments, the agent update module 310 may also be configured to similarly update any number of rules 305 based upon update messages received from the security system 108. The agent update module 310 may receive one or more rules from the password update message 103b sent from the security system 108. In some embodiments, the agent update module 310 may generate new rules based on information from the update message 103b. In one example, the agent update module 310 may look up a rule in the rule database 305 with a rule identifier specified in the received update message, and replace the existing “old” rule with the “new” rule contained in the received message. Alternatively, the module 310 may upon only update a portion of the rule (e.g., a trigger condition) as opposed to replacing the whole rule.

In some embodiments, the agent update module 310 may change all or part of any rule. The agent update module 310 may change all or part of any rule based on information from the update message 103b or without any information from the update message 103b (e.g., the agent update module 310 may utilize instructions on the client device 102 to change rules and/or passwords on the client device 102). In various embodiments, the agent update module 310 may update rules and/or passwords utilizing any messages and/or information from the security system 108, manager device 104, or the administrator device 106.

The agent communication module 314 may be configured to provide communication between the client device 102 and the security system 108. In some embodiments, the communication module 314 may also be configured to communicate between the security agent 202 and the security system 108. For example, the communication module 312 may establish an active communication connection between the client device 102 and the security system 108, and the security agent 202 may send password update request 103a via that connection.

The agent encrypt/decrypt client module 314 is configured to encrypt, decrypt, and/or otherwise secure information during communication between the client device 102 and the security system 108 and/or information stored by the security agent 202. The encrypt/decrypt client module 212 may encrypt, decrypt, or otherwise secure information in any number of ways including, but not limited to, those described herein. For example, module 314 may encrypt password update requests 103a sent to the security system 108, and decrypt password update messages 103b received from the security system 108. In some embodiments, the encryption/decryption protocols utilized by the module 314 are defined in the rules 305.

The agent authentication module 316 is configured to authenticate password received, generated, and/or applied by the update module 310. For example, if the update fails, the module 316 may send a failure message to the security system 108 notifying it that the update was not successful. Alternatively, if the update succeeds, the module 316 may send a success message to the security system 108 notifying it that the update was successfully applied. The success/failure messages may include, for example, a digital device identifier and account identifiers that identify the client device and accounts that received the updates. In some embodiments, if the update was unsuccessful, the authentication module 316 may trigger the security agent 202 to provide another password update request 103a, and/or alert an administrator. Additionally, the authentication module 316 may store authentication results (e.g., for review by an administrator).

In some embodiments, the agent authentication module 316 may be configured to authenticate a source of incoming messages (e.g., password update messages 103b). The agent authentication module 314 may authenticate incoming messages, for example, based upon authentication data contained within the incoming messages. This may prevent, among other things, “man in the middle” attacks. In some embodiments, the rules for appropriately authenticating a source of incoming messages 103b may be defined in rules 305. Authentication may utilize, for example, challenge messages, encryption, 3^{rd} party authentication, and the like.

It will be appreciated that a “module,” “agent,” or “database” may be or comprise software, hardware, firmware, and/or circuitry. In one example, one or more software programs comprising instructions capable of being executable by a processor (e.g., processor 704 described with regard to FIG. 7) may perform one or more of the functions of the modules, databases, or agents described herein. In another example, circuitry may perform the same or similar functions. The circuitry may utilize, for example, an ASIC or other processing device.

Alternative embodiments may comprise more, less, or functionally equivalent modules, agents, or databases, and still be within the scope of present embodiments. For example, as previously discussed, the functions of the various modules, agents, or databases may be combined or divided differently. It will also be appreciated that some of the modules identified in FIG. 3 are optional (e.g., the agent encrypt/decrypt module 312 and the agent authentication module 316 may be optional).

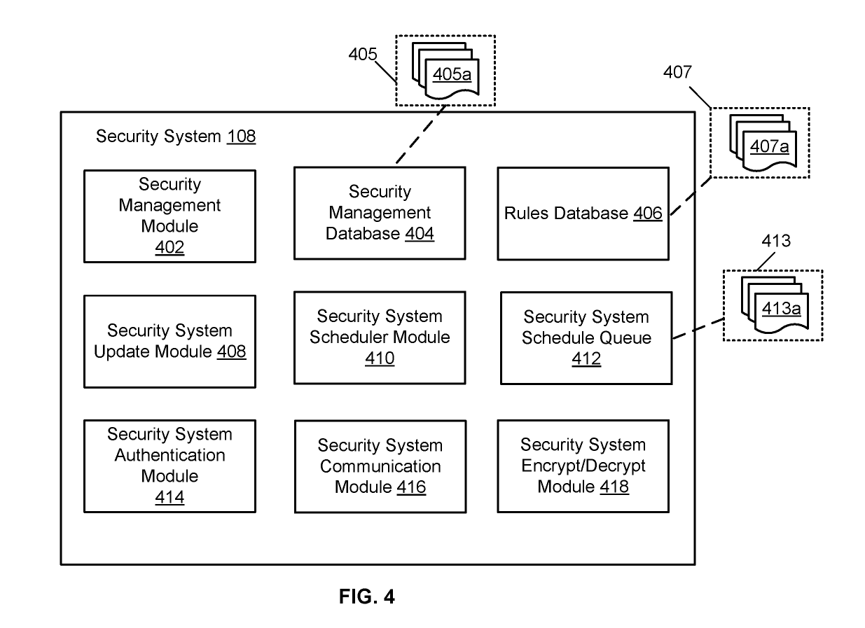

FIG. 4 is a block diagram of one embodiment of a security system according to some embodiments. FIG. 4 is a block diagram of a security system 108 according to some embodiments. In some embodiments, the security system 108 includes a security management module 402, a security management database 404, a rules database 406, a security system update module 408, a security system scheduler module 410, a security system schedule queue 412, a security system authentication module 414, a security system communication module 416, and a security system encrypt/decrypt module 418. The security system 108 may be configured to generate and store update schedule records 413 whenever a password update is required for a client device. For example, when the security agent 202 connects to the security system 108 with a password update request 103a, the security system 108 may check the schedule queue 412 for any update schedule records 413 indicating that an updated password is required for one or more accounts 204 on the client device 102.

The security management module 402 is configured to create, read, update, delete, and/or otherwise access, device records 405 stored in the security management database 404 and the rules 407 stored in the rules database 408. The security management module 402 may perform any of these operations either manually (e.g., by an administrator interacting with a GUI) or automatically (e.g., by the security system update module 408). In some embodiments, any of device records 405 store a variety of information about the client device 102 and/or other devices that connect to the security system 108 (e.g., via network 126). For example, the device records 405 could store device identifiers (e.g., MAC addresses, IP addresses, Firmware identifiers, or the like), account identifiers, rule identifiers, security agent identifiers, passwords, password identifiers, application identifiers, log entries, log entry identifiers, network connection status identifiers, password status (e.g., current, expired, requires updating, and the like) and so forth.

In some embodiments, each device record 405 may include a digital device identifier that identifies a client device 102 in non-persistent communication with the security system 108. For example, device record 405a may include a device identifier that identifies client device 102. The device records 405 may also include an encrypted password associated with the digital device identifier, and a rule (or “policy”) identifier that identifies a rule (or “policy”) from a set of rules 407. In some embodiments, each of the device records 405 may include a password identifier instead of the password itself. That password identifier may identify an encrypted password stored elsewhere on the security system 108, or other device connected thereto.

It will be appreciated that the device records 405 may not include a password. In some embodiments, a device record may identify when a password was last changed on a device and/or account. The device record may further indicate whether a change of password is due or whether a change is not due.

The rules 407 may be stored in rules database 406 and may each define one or more conditions that, when satisfied, trigger the security system 108, or component thereof (e.g., security management module 402, security system update module 408, or security system scheduler module 410) to generate updates (e.g., password updates, rule updates, and so forth) for associated accounts or to indicate that a update should be generated. Example conditions may include a date and/or time (e.g., a password “expiration” date/time), a time interval (e.g., every 2 weeks), or an event. An event may be, for example, an intrusion detected by the security system 108 or client device, a network failure, or other predetermined event defined by an administrator or other user with sufficient privileges. In some embodiments, the rules 407 may define encryption/decryption protocols used by the security system encrypt/decrypt module 418, discussed below.

In some embodiments, the security system management module 402 comprises a library of executable instructions each of which may be executable by a processor (e.g., a processor 704 further described with regard to FIG. 7) for performing any of the aforementioned operations. The library may comprise any number of methods (e.g., one or more programs) stored in the library may be configured to change the password to an SQL database. It will be appreciated that the security management database 404 may be any structure (e.g., active database, relational database, table, and so forth, and the like) suitable for storing the aforementioned records.

The security system update module 408 may determine and/or select which of the devices (e.g., an account, hardware system, operating system, firmware, or the like) require updating (e.g., password update). The security system update module 408 may also determine which rules 407 of the rules database 406 require changes. In some embodiments, the security system update module 408 selects an individual device record based upon the rule identified in that device record, and generates an update based on the policy identified in that device record. For example, device record 405a may identify the rule 407a that may specify that any associated record (e.g., record 405a) requires a password update once a week. In various embodiments, the security system update module 408 selects an individual device record based upon the rule identified in the device record and indicates an update should be generated by a digital device (e.g., by the client device 102 or the security system 108).

In some embodiments, the security system scheduler module 410 may generate update schedule records 413 based on rules identified in the device records 405. Each of the update schedule records 413 may include a digital device identifier that identifies an associated client device and one or more account identifiers that identify one or more accounts on that client device 102. The update schedule records 413 may also include a rule identifier designating a rule associated with the digital device for updating. The aforementioned identifiers may each be a number, character, string, or otherwise.

The security system scheduler module 410 may also store the update schedule records 413 in the schedule queue 412, based upon a determination, by the security system scheduler module 410, that the digital device identified in the update schedule record is not in active communication with the security system 108. Thus, for example, when the client device 102 sends the password update request 103a to the security system 108, the security system 108 may check the schedule queue 412 for any schedule records with matching device and/or account identifiers. It will be appreciated that in other embodiments the schedule queue 412 may comprise another type of data structure (e.g., table) suitable for storing schedule records 413.

The security system authentication module 414 may determine whether any of the accounts 204 installed on the client device 102 require a password update. This may be determined, for example, by searching the schedule queue 413 for an update schedule record having a digital device identifier matching the digital device identifier included in the password update request 103a. In some embodiments, the security system authentication module 414 may also authenticate a source of messages sent to the security system 108. Thus, for example, the security system authentication module 414 may verify that the update request 103a actually originated from the client device 102, as opposed to an illegitimate device, such as a device used by a hacker in a man-in-the-middle attack. The security system authentication module 414 may authenticate a source of incoming messages based on authentication data included in the message.

In some embodiments, the security system authentication module 414 may verify whether a password update was successfully applied by a client device 102. For example, the security system authentication module 414 may receive a message from the agent authentication module 316 indicating that the password update 103b was either successfully or unsuccessfully applied by the client device 102. If the update was unsuccessful, the security system authentication module 414 may trigger the security system 108 to issue another password update message 103b, and/or alert an administrator. Additionally, the security system authentication module 414 may store authentication results (e.g., for review by an administrator).

The security system communication module 416 is configured to provide communication between the security system 108 and the client device 102. In some embodiments, the security system communication module 416 may also be configured to communicate between the security system 108 and the security agent 202. The security system communication module 416 may also be configured to establish an encrypted communication (e.g., VPN, HTTPS, SSL, and so forth) with the client device 102 and/or the security agent 202.

The security system encrypt/decrypt module 418 may be configured to provide encryption, decryption, or other security measures for the security system 108. For example, the security system encrypt/decrypt module 418 may be able to encrypt password update messages sent to the client device 102, and decrypt password update request messages received from the client device 102. In some embodiments, the security system encrypt/decrypt module 314 issues a program key. A program key may be an SSH DSS private key or an X509v3 client certificate, for example. The security system 108 may issue a program key for use on behalf a program account. In some embodiments, the program key may be a required parameter for API functions.

In some embodiments, the security system 108 does not allow direct access to the operating system on the security system 108. Further, the security system 108 may comprise a firewall (e.g., with IPSEC support) to prevent hacking. Moreover, the security system 108 may perform encryption, such as FIPS-140 validated components, and perform hard disk AES 256-bit encryption for whole disk encryption. Passwords, once generated, may be stored with x509v3 certificates. In some embodiments, inbound connections may be only through HTTPS and SSH. The security system 108 may also support single- or two-factor authentication using LDAP Active Directory, SecureID, Safeword, and x509v3 certificates. The security system 108 may perform any or more than the functions listed herein.

As discussed herein, one or more software programs comprising instructions capable of being executable by a processor (e.g., processor 704 described with regard to FIG. 7) may perform one or more of the functions of the modules, databases, or agents described herein. In another example, circuitry may perform the same or similar functions. The circuitry may utilize, for example, an ASIC or other processing device.

Alternative embodiments may comprise more, less, or functionally equivalent modules, agents, or databases, and still be within the scope of present embodiments. For example, as previously discussed, the functions of the various modules, agents, or databases may be combined or divided differently. It will also be appreciated that some of the modules identified in FIG. 4 are optional.

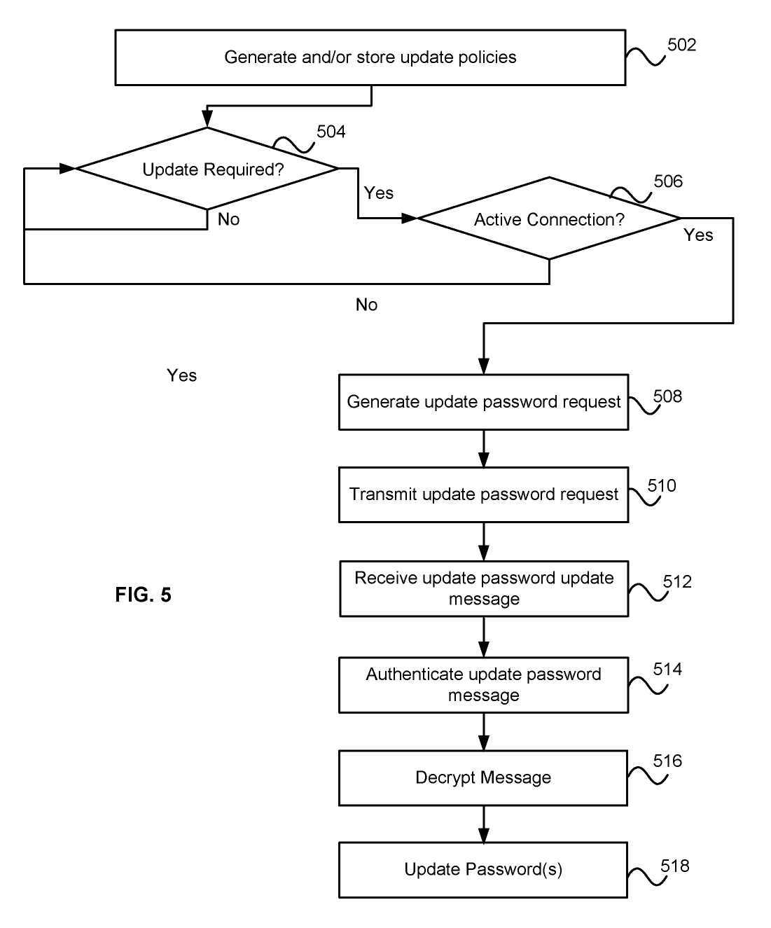

FIG. 5 is a flow diagram of one embodiment of a method of operation for a security agent according to some embodiments. FIG. 5 is an example method of operation for a security agent 202 according to some embodiments. In some embodiments, operation of the security agent may include a greater or lesser number of such steps.

In step 502, the security agent 202, executed by client device 102, generates and/or stores update policies and/or rules. The update policies may be stored in a memory that may be hardware (e.g., SSD, HDD, RAM, and the like), software (e.g., database, table, and so forth), or combination thereof. Each rule may include, for example, a rule identifier that identifies the rule, one or more account identifiers that each identifies one of the accounts (e.g., accounts 204) installed on the client device 102, and one or more conditions that may trigger a password update for the identified accounts. In some embodiments, the rules 305 are generated and stored in rules database 304 by a security agent management module 302.

In step 504, the security agent 202 determines, based on the update policies whether an updated password is required for any of the accounts installed on the digital device. For example, an updated password may be required if a current password is “old” or “expired,” or if the digital device or server processor was compromised (e.g., hacked). In some embodiments, accounts may be manually flagged for a password update (e.g., by an administrator). If an update is not required, then the security agent 202 may wait until an update is required. In some embodiments, the agent detection module 306 determines whether an update is required.

If an update is required, the security agent determines whether an active communication connection is available with the security system (step 506). If an active communication connection is unavailable, the security agent 202 may wait until one becomes available. In some embodiments, the detection module determines whether the client device 102 is in active communication with the security system.

In step 508, the security agent 202 generates a password update request (e.g., request 103a) in response to a determination by the agent detection module 306 that the client device 102 is in active communication with the security system 108 and that, based upon the update policy, an updated password is required for one or more of the accounts. In some embodiments, the security agent update module 310 may generate the password update request.

In step 510, the security agent 202 transmits the password update request for receipt by the security system 108. In some embodiments, the agent communication module 314 transmits the update request.

In step 512, the security agent 202 receives an update password message 103a sent from the security system 108. The update password message 103a may include one or more encrypted updated passwords and/or associated account identifiers. In some embodiments, the update password message does not include a new password. The security agent 108 may generate new passwords in response to receiving the update password message from the security system.

In step 514, the security agent 202 authenticates an origin of the received password update message. This may prevent, for example, receiving a “spoofed” message. In some embodiments, the security agent authentication module 316 may authenticate the message based authentication data contained within the message. If the authentication fails, the security agent 202 may alert an administrator, or other user with sufficient privileges, and/or may log the failure and/or notify the server processor of the failed authentication.

If the authentication succeeds, the security agent 202 optionally decrypts the password update message, and contents thereof (step 516). If the decryption fails, the security agent 202 may alert an administrator, or other user with sufficient privileges, and/or may log the failure and/or notify the server processor of the failed decryption. In some embodiments, the security agent encrypt/decrypt module 312 may use a decryption protocol defined in the rules 305 to decrypt the message.

If the decryption succeeds, the security agent 202 may update one or more old passwords associated with one or more accounts identified in the password update message (step 518). The old passwords may be updated by replacing them with the encrypted updated passwords contained within the received password update message from the security system 108. In some embodiments, the agent update module 310 updates the old passwords. In various embodiments, the security agent 202 may provide the updated passwords (e.g., updated, encrypted passwords) to the security system 108 which may store the encrypted passwords from the security agent 202.

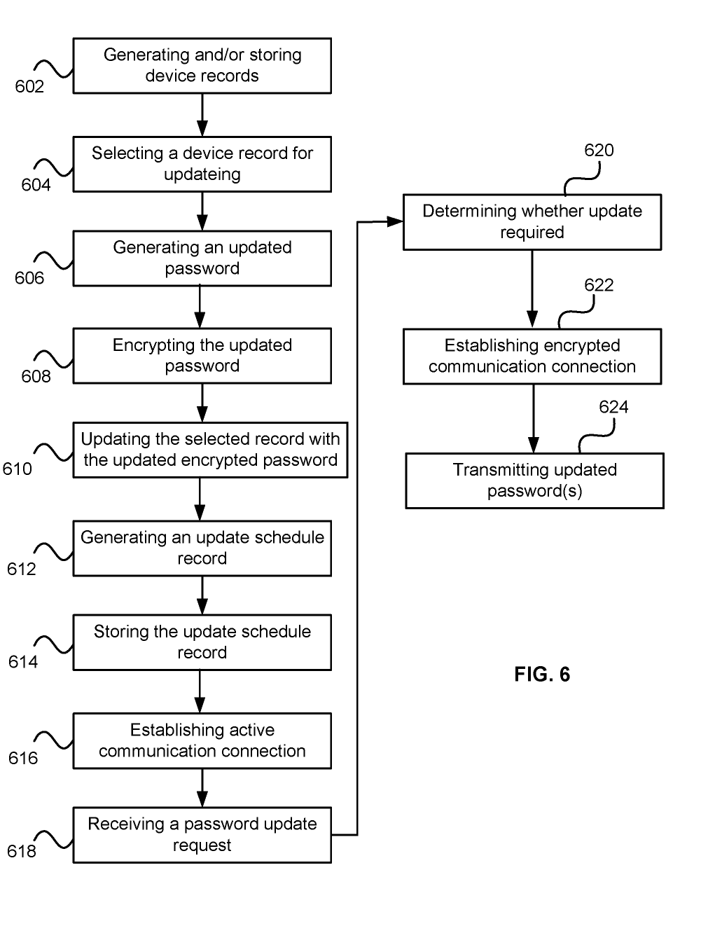

FIG. 6 is a flow diagram of one embodiment of a method of operation for a security system according to some embodiments. FIG. 6 is an example method of operation for a security system (e.g., security system 108) according to some embodiments. In some embodiments, operation of the security system may include a greater or lesser number of such steps.

In step 602, the security system 108 generates and stores device records 405 in a memory. The memory may be hardware (e.g., SSD, HDD, RAM, and any other kind of computer readable media), software (e.g., database 404), or combination thereof. Each device record includes a digital device identifier that identifies the client device 102 in non-persistent communication with the security system 108 via a computer network (e.g., network 126). The device records also each store an encrypted password associated with the digital device identifier, as well as a policy identifier and/or rules 407a. The policy identifier may identify a policy that indicates when an updated password should be generated by the security system for one or more accounts (e.g., accounts 204) installed on the digital device. In some embodiments, more specifically, the security management module 402 generates and/or stores the device records.

In step 604, the security system 108 selects the device record 405a for updating based upon the policy identified in that device record. For example, the policy may specify that the device record should be updated once a week, or some other predetermined amount of time. The update may indicate that the associate device and/or account should update one or more passwords when the security agent 108 of the client device 102 next communicates with the security system 108. In step 606, the security system 108 optionally generates an updated password based on that policy. For example, the security system update module 402 selects the record for updating and generates the updated password.

In step 608, the security system 108 optionally encrypts the updated password based upon a predetermined encryption protocol. In some embodiments, the security system encrypt/decrypt module 418 encrypts the password, and the predetermined encryption protocol is defined in the identified policy and/or rule 407a.

In step 610, the security system 108 updates the encrypted password defined in the selected device record with the encrypted updated password. In some embodiments, more specifically, the encryption module updates the encrypted password. In other embodiments, the update module may update the encrypted password.

In step 612, the security system generates the update schedule record 413a based on the policy defined in the selected device record. The update schedule record may include, for example, the digital device identifier that was defined in the selected device record. In step 614, the security system 108 stores the update schedule record in the security schedule queue 412 if the identified digital device is currently unavailable to receive communication from the security system 108. For example, the security system scheduler module 410 may generate the update schedule record.

In some embodiments, if a password update is triggered by the security system 108 in response to a satisfied condition or event defined in the identified policy, when the identified client device 102 is in active communication with the security system 108, it may then directly transmit the updated password(s) to the client device 102 (i.e., without generating a schedule record and/or without receiving a password update request from the client device 102, and the like). In various embodiments, if a password update is triggered (e.g., by the security system) in response to a satisfied condition or event defined in the identified policy when the identified client device 102 is in active communication with the security system 108, the security system 108 may then provide a message to the client device that the password for the device should be updated.

In step 616, an active communication connection is established at the security system 108. The active communication connection may, for example, enable the security system to receive a password update request 103a from the client device 102.

In step 618, the security system 108 receives the password update request 103a initiated from the security agent 202 executing on the client device 102. The password update request may include a variety of attributes and/or characteristics that allow the security system 108 to identify the digital device from among a variety of different devices. For example, the request may include a digital device identifier. In some embodiments, more specifically, the security system communication module 416 establishes the active communication connection and/or receives the password update.

In step 620, the security system 108 determines, in response to receiving the password update request, whether the first digital device requires a password update by searching the memory for an update schedule record having a digital device identifier matching the digital device identifier defined in the password update request. For example, the security system authentication module 414 determines if the password update is required.

In step 622, an encrypted active communication connection (e.g., VPN, HTTPS, SSL, and the like) is established at the security system 108 in response to finding the update schedule record (e.g., record 413a) having the matching digital device identifier. The encrypted active communication connection may enable, for example, the security system 108 to transmit the encrypted updated password to the client device 102. In some embodiments, the security system communication module 416 establishes the encrypted communication connection.

In step 624, the security system 108 transmits the encrypted updated password message and/or one or more passwords via the encrypted communication connection for receipt by the security agent executing on the client device 102. The client device 102 may decrypt the encrypted updated password, and update an old password on the client device 102 with the decrypted updated password. In some embodiments, the communication module transmits the updated password (e.g., password update 103b).

FIG. 7 is a block diagram of one embodiment of a digital device according to some embodiments. FIG. 7 is a block diagram of an example digital device 702 according to some embodiments. Any of the client device 102, the manager device 104, the administrator device 106, the security system 108, routers/switches 110, firewalls 112, the windows servers 114, the Unix® servers 116, the Linux® servers 118, the AS/400 servers 120, the z/OS mainframes 122, and databases 124 may be an instance of the digital device 702. The digital device 702 comprises a processor 704, memory 706, storage 708, an input device 710, a communication network interface 712, and an output device 714 communicatively coupled to a communication channel 716. The processor 704 is configured to execute executable instructions (e.g., programs). In some embodiments, the processor 704 comprises circuitry or any processor capable of processing the executable instructions.

The memory 706 stores data. Some examples of memory 706 include storage devices, such as RAM, ROM, RAM cache, virtual memory, and so forth. In various embodiments, working data is stored within the memory 706. The data within the memory 706 may be cleared or ultimately transferred to the storage 708.

The storage 708 includes any storage configured to retrieve and store data. Some examples of the storage 708 include flash drives, hard drives, optical drives, and/or magnetic tape. Each of the memory system 706 and the storage system 708 comprises a computer-readable medium, which stores instructions or programs executable by processor 704.

The input device 710 is any device that inputs data (e.g., mouse and keyboard). The output device 714 outputs data (e.g., a speaker or display). It will be appreciated that the storage 708, input device 710, and output device 714 may be optional. For example, the routers/switchers 110 may comprise the processor 704 and memory 706 as well as a device to receive and output data (e.g., the communication network interface 712 and/or the output device 714).

The communication network interface (com. network interface) 712 may be coupled to a network (e.g., network 126) via the link 718. The communication network interface 712 may support communication over an Ethernet connection, a serial connection, a parallel connection, and/or an ATA connection. The communication network interface 712 may also support wireless communication (e.g., 802.11 a/b/g/n, WiMAX, LTE, Wi-Fi). It will be apparent to those skilled in the art that the communication network interface 712 may support many wired and wireless standards.

It will be appreciated by those skilled in the art that the hardware elements of the digital device 702 are not limited to those depicted in FIG. 7. A digital device 702 may comprise more or less hardware, software and/or firmware components than those depicted (e.g., drivers, operating systems, touch screens, biometric analyzers, and so forth). Further, hardware elements may share functionality and still be within various embodiments described herein. In one example, encoding and/or decoding may be performed by the processor 704 and/or a co-processor located on a GPU (e.g., Nvidia®).

It will further be appreciated that although the example method steps described herein (e.g., steps 502-518 and 602-624) are described in a specific order, each of the steps may also be performed in a different order. Each of the steps may also be performed sequentially and/or in parallel with one or more of the other steps. In other embodiments, the methods may include a lesser or greater number of such steps.

The above-described functions and components may comprise instructions that are stored on a storage medium such as a computer readable medium. Some examples of instructions include software, program code, and firmware. The instructions may be retrieved and executed by a processor in many ways.

The systems and methods described herein are with reference to example embodiments. It will be appreciated that various modifications may be made and other embodiments may be used without departing from the broader scope of the present disclosure. Therefore, these and other variations upon the example embodiments are intended to be covered by the present disclosure.

The methods and systems disclosed herein are not limited to a particular hardware or software configuration, and may find applicability in many computing or processing environments. The methods and systems may be implemented in hardware or software, or a combination thereof. The methods and systems may be implemented in one or more computer programs, where a computer program may be understood to include one or more processor executable instructions. The computer program(s) may execute on one or more programmable processors, and may be stored on one or more storage mediums (i.e., computer readable medium) readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation. Those skilled in the art will appreciate that the RAM, RAID, floppy disks, optical medium (e.g., CD and DVD disks), magnetic disks, internal hard drive, external hard drive, memory stick or other storage device may also be computer readable mediums.

The computer program(s) may be implemented using one or more high level procedural or object-oriented programming languages to communicate with a computer system. However, the program(s) may be implemented in assembly or machine language, if desired. The language may be compiled or interpreted.

The processor(s) may be embedded in one or more devices that may be operated independently or together in a networked environment, where the network may include, for example, a local area network (LAN), wide area network (WAN), an intranet, the Internet, and/or another network. The network(s) may be wired, wireless, or a combination thereof and may utilize one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single or multiple processor/devices.

The device(s) (e.g., computers) that integrate with the processor(s) may include, without limitation, for example, a personal computer(s), workstation (e.g., Sun®, Hewlett Packard®), personal digital assistant (PDA), handheld device such as cellular telephone, laptop, handheld, or another device capable of being integrated with a processor(s) that may operate as provided herein. Accordingly, the devices provided herein are not exhaustive and are provided for illustration and not limitation. Similarly, as used herein a system may be a single digital device (e.g., a computer) or may comprise multiple digital devices.

As used herein, the terms “microprocessor” and “processor,” may be understood to include one or more microprocessors that may communicate in a stand-alone and/or a distributed environment(s), and may thus may be configured to communicate via wired or wireless communications with other processors, wherein such one or more processor may be configured to operate on one or more processor-controlled devices that may be similar or different devices. Use of such “microprocessor” or “processor” terminology or the like may thus also be understood to include a central processing unit, an arithmetic logic unit, an application-specific integrated circuit (IC), and/or a task engine, with such examples provided for illustration and not limitation.

Furthermore, memory, unless otherwise specified, may include, without limitation, one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix®, Oracle®) and also proprietary databases, and may also include other structures for associating memory such as links, queues, graphs, trees, with such structures provided for illustration and not limitation.

References to a network, unless provided otherwise, may include, without limitation, one or more intranets and/or the Internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Accordingly, it will be understood that the disclosed methods and systems are not to be limited to the embodiments disclosed herein, may include practices otherwise than specifically described, and are to be interpreted as broadly as allowed under the law.

The methods and systems described herein may be deployed in part or in whole through a machine that executes computer software, application, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, in some embodiments, other devices may be required for execution of methods as described in this application may be considered as a part of the infrastructure associated with the server.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, in some embodiments, other devices may be required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the embodiments discussed herein. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While various embodiments have been disclosed and described in detail, various modifications and improvements thereon will become readily apparent to those skilled in the art. Accordingly, the spirit and scope of the present description is not to be limited by the foregoing examples, but is to be understood in the broadest sense allowable by law.

All documents referenced herein are hereby incorporated by reference.

While the foregoing written description enables one of ordinary skill to make and use what is considered presently to be the best mode thereof, those of ordinary skill will understand and appreciate the existence of variations, combinations, and equivalents of the specific embodiment, method, and examples herein. These embodiments therefore are not be limited by the above described illustrated embodiments, methods, and examples, but by all embodiments and methods within the scope as claimed.

Except as stated immediately above, nothing which has been stated or illustrated is intended or should be interpreted to cause a dedication of any component, step, feature, object, benefit, advantage, or equivalent to the public, regardless of whether it is or is not recited in the claims.

1. A computer-implemented method for providing agent-based password updates comprising:
storing, in a memory configured to cooperate with a processor, a plurality of device records;
wherein at least one device record of the plurality of device records comprises:
a digital device identifier that identifies at least one digital device in non-persistent communication with the processor,
a current password associated with the digital device identifier, and
a policy identifier that identifies at least one policy indicating when an updated password will be generated by the processor for the at least one digital device identified by the digital device identifier;
determining, by the processor, whether at least one condition identified by the at least one policy is satisfied;
generating, by the processor, an updated password to replace the current password only if the at least one condition is satisfied;
receiving, by the processor, a password update request initiated from a security agent executing on the at least one digital device, the password update request comprises the at least one device identifier that identifies the at least one digital device; and
providing, by the processor to the at least one digital device, the updated password to replace the current password on the at least one digital device only if the at least one condition is satisfied.

2. The method of claim 1, further comprising the steps:
determining, by the processor, whether the current password on the at least one digital device was successfully updated based upon a message sent from the at least one digital device.

3. The method of claim 2, further comprising the steps:
generating, by the processor, a second updated password in response to determining that the current password was not successfully updated, and transmitting the second updated password to the at least one digital device.

4. The method of claim 1, wherein the at least one policy identified in the at least one device record indicates the at least one condition is selected from the group of conditions consisting of: an elapsed predetermined period of time since a last update; a scheduled date; and a frequency of update of the at least one digital device.

5. The method of claim 1, wherein the updated password is generated after the password update request is received by the processor.

6. The method of claim 1, further comprising the steps:
encrypting, by the processor, the updated password based upon a predetermined encryption protocol.

7. The method of claim 1, further comprising the steps:
establishing an active communication connection between the processor and the at least one digital device, the active communication connection allows the processor to receive the password update request.

8. The method of claim 7, further comprising the steps:
storing, by the processor, the updated password; and
updating the at least one device record.

9. The method of claim 1, further comprising the steps:
updating an update schedule record associated with the at least one policy, the update schedule record indicating when the at least one digital device received the updated password.

10. The method of claim 9, wherein the step of determining, by the processor, whether the at least one condition identified by the at least one policy is satisfied comprises:
determining, by the processor, whether the at least one condition is satisfied based, at least in part, on the update schedule record.

11. A system comprising:
a processor; and
memory, the memory comprising:
a security management database storing a plurality of device records, at least one device record of the plurality of device records comprising:
a digital device identifier that identifies at least one digital device in non-persistent communication with the processor,
a current password associated with the digital device identifier, and
a policy identifier that identifies at least one policy indicating when an updated password will be generated by the processor for the at least one digital device identified by the digital device identifier;
a security system update module configurable by the processor to determine whether at least one condition identified by the at least one policy is satisfied and to generate an updated password to replace the current password only if the at least one condition is satisfied; and
a security system communication module configurable by the processor to:
receive a password update request initiated from a security agent executing on the at least one digital device, the password update request comprising the at least one device identifier that identifies the at least one digital device, and
provide the updated password to the at least one digital device to replace the current password on the at least one digital device only if the at least one condition is satisfied.

12. The system of claim 11, the memory further comprising:
a security system authentication module configurable by the processor to determine whether the at least one password on the at least one digital device was successfully updated based upon a message sent from the at least one digital device.

13. The system of claim 12, wherein the security system update module is further configurable by the processor to generate a second updated password in response to determining that the current password was not successfully updated, and the security system communication module is further configurable by the processor to transmit the second updated password to the at least one digital device.

14. The system of claim 11, wherein the at least one policy identified in the at least one device record indicates the at least one condition is selected from the group of conditions consisting of: an elapsed predetermined period of time since a last update; a scheduled date; and a frequency of update of the at least one digital device.

15. The system of claim 11, wherein the updated password is generated after the password update request is received by the processor.

16. The system of claim 11, the memory further comprising:
a security system encrypt/decrypt module configured to encrypt the updated password based upon a predetermined encryption protocol.

17. The system of claim 11, wherein the security system communication module is further configurable by the processor to establish an active communication connection between the processor and the at least one digital device, the active communication connection allows the processor to receive the password update request.

18. The system of claim 11, wherein the security system update module is further configurable by the processor to store the updated password and update the at least one device record.

19. The system of claim 11, the memory further comprising:
a security system schedule queue configured to update an update schedule record associated with the at least one policy, the update schedule record indicating when the at least one digital device received the updated password;
wherein the security system update module configurable by the processor to determine whether the at least one condition identified by the at least one policy is satisfied comprises:
determining whether the at least one condition is satisfied based, at least in part, on the update schedule record.

20. A non-transitory computer readable medium comprising executable instructions, the executable instructions being executable by a processor to perform a method, the method comprising the steps:
storing, in a memory configured to cooperate with the processor, a plurality of device records, at least one device record of the plurality of device records comprising:
a digital device identifier that identifies at least one digital device in non-persistent communication with the processor,
a current password associated with the digital device identifier, and
a policy identifier that identifies at least one policy indicating when an updated password will be generated by the processor for the at least one digital device identified by the digital device identifier;
determining, by the processor, whether at least one condition identified by the at least one policy is satisfied;
generating, by the processor, an updated password to replace the current password only if the at least one condition is satisfied;
receiving, by the processor, a password update request initiated from a security agent executing on the at least one digital device, the password update request comprising the at least one device identifier that identifies the at least one digital device; and
providing, by the processor to the at least one digital device, the updated password to replace the current password on the at least one digital device only if the at least one condition is satisfied.
